(19) United States
(12) Patent Application Publication
(10) Pub. No.: US 2012/0230605 A1
(43) Pub. Date: Sep. 13, 2012

(54) COMPUTING DEVICE AND OFFLINE PROGRAMMING METHOD

(75) Inventors: CHIH-KUANG CHANG, Tu-Cheng (TW); ZHONG-KUI YUAN, Shenzhen City (CN); LI JIANG, Shenzhen City (CN); DONG-HAI LI, Shenzhen City (CN); XIAO-GUANG XUE, Shenzhen City (CN)

(73) Assignees: HON HAI PRECISION INDUSTRY CO., LTD., Tu-Cheng (TW); Hong Fu Jin Precision Industry (ShenZhen) Co., Ltd, Shenzhen City (CN)

(21) Appl. No.: 13/407,771

(22) Filed: Feb. 29, 2012

(30) Foreign Application Priority Data
Mar. 8, 2011 (CN) 201110055623.5

(51) Int. Cl. G06K 9/36

(52) U.S. Cl. 382/282

(57) ABSTRACT

A computing device and method for programming a measuring program into the device. The system and method divide an ideal image into one or more sections and obtains the attributes of each of the sections. The system and method measure dimensions from a desired position located in each of the sections based on a coordinate system created for each of the sections, and obtains ideal measurements from the desired position. The system and method generate a measuring program which is capable of executing the steps mentioned above.

### BACKGROUND

1. Technical Field

Embodiments of the present disclosure generally relate to measurement technology, and more particularly to a method of programming for a computing device.

2. Description of Related Art

Coordinate measuring machines (CMMs) measure manufactured parts. The measurements of the manufactured parts can determine if the manufactured parts meet design specifications and can provide information for improvements in process control. Programming speed of CMMs can be a bottleneck in the manufacturing process. In networked systems, online programming is a popular programming method. However, the online programming is slow, and a CMM may remain idle during programming. Additionally, the program may use a coordinate system to measure manufactured parts. When the manufactured parts are very complicated, for example, including irregular shapes (e.g., one or more non-uniform rational basis spline (NURBS) surfaces), one coordinate system is not enough for accurately measuring the manufactured parts.

### BRIEF DESCRIPTION OF THE DRAWINGS

FIG. 1 is a block diagram of one embodiment of a computing device including an offline programming unit.

FIG. 2 is a block diagram of one embodiment of the offline programming unit in FIG. 1.

FIG. 3 is a flowchart illustrating one embodiment of an offline programming method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

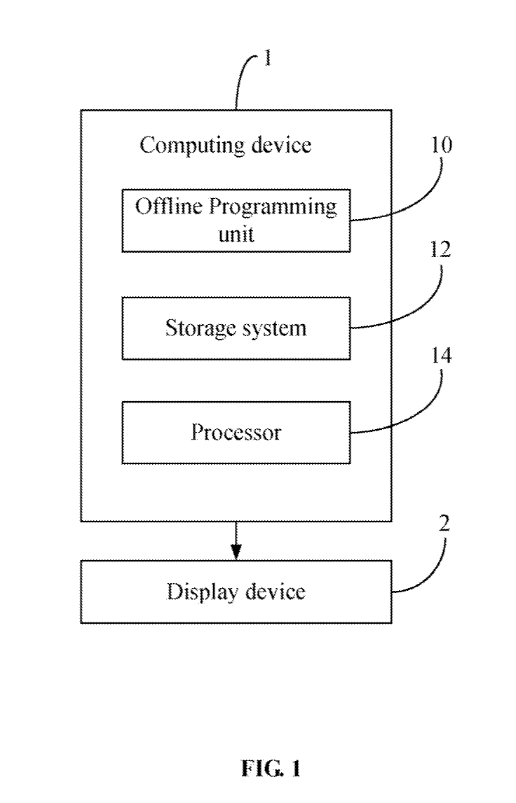

FIG. 1 is a block diagram of one embodiment of an computing device 1 including an offline programming unit 10. In the embodiment, the functions of the offline programming unit 10 are implemented by the computing device 1. The offline programming unit 10 generates a measuring program that is used to measure the product (e.g., a part of a mobile phone) according to attributes of geometric elements of the product, executes the measuring program to measure the product, and records measurement data. In the embodiment, the measuring program can be written in a programming language, such as, for example, Java, C, or assembly. The measuring program is executable by the computing device 1. The measuring program is a software program which is capable of automatically measuring other products (e.g., a part of a mobile phone) of the same type.

In one embodiment, the computing device 1 may be a computer, a server, a portable electronic device, or any other electronic device that includes a storage system 12, and at least one processor 14. In one embodiment, the storage system 12 may be a magnetic or an optical storage system, such as a hard disk drive, an optical drive, a compact disc, a digital video disc, a tape drive, a flash, a cache, a flash memory, an EPROM, a flash memory, or other suitable storage medium. The processor 14 may be a central processing unit including a math co-processor, for example.

The computing device 1 is electronically connected to a display device 2. The display device 2 is operable to display the measuring program that includes a measuring process and results of measuring on the product.

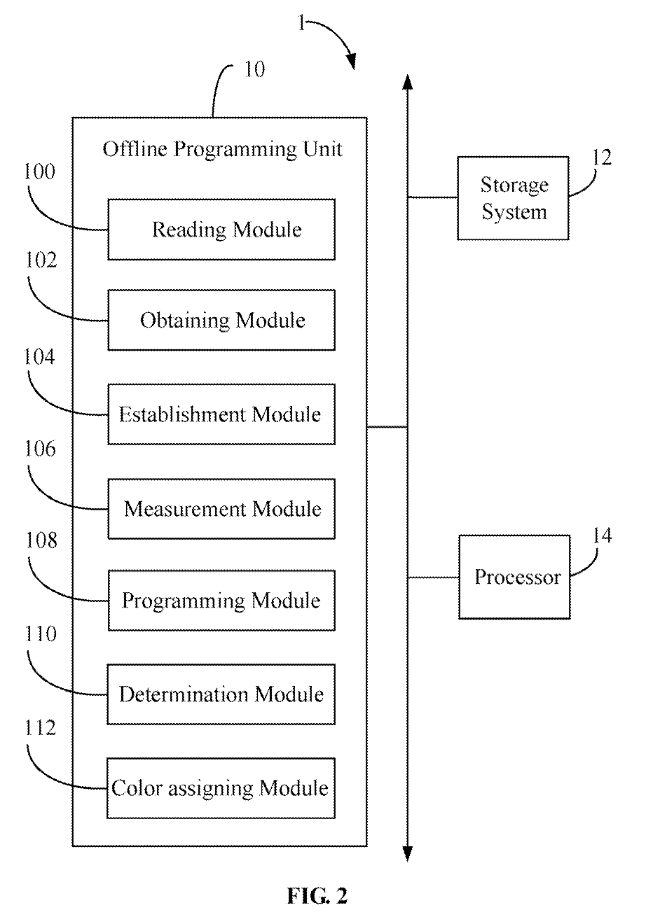

FIG. 2 is a block diagram of one embodiment of the computing device 1 including an offline programming unit 10. In one embodiment, the offline programming unit 10 includes an reading module 100, an obtaining module 102, an establishment module 104, a measurement module 106, a programming module 108, a determination module 110 and a color assigning module 112. The modules 100-112 may include computerized code in the form of one or more programs that are stored in the storage system 12. The computerized code includes instructions that are executed by the at least one processor 14 to provide functions for modules 100-112.

The reading module 100 reads an ideal image of a product from the storage system 12. The ideal image of the product can be drawn by an image drawing application, such as, a computer aided design (CAD) or a PRO/ENGINEER. The ideal image may express the best representation of the shape(s) of the product (e.g., a component of a mobile phone). In the embodiment, the ideal image may include serial numbers, geometric elements, and attributes of each of the geometric elements. The geometric elements may be a point, a line, a circle, a flat surface, a plane, a conventional surface (e.g., a ruled surface), a non-uniform rational basis spline (NURBS) surface or the like. In one embodiment, the conventional surface is defined by Initial Graphics Exchange Specification (IGES), and the conventional surface may be one of, but are not limited to, a ruled surface, a cylindrical surface, and a rotating surface. The serial numbers dictate a position and location of any geometric element which has been stored in the ideal image. The attributes of each of the geometric elements is information concerning the construction and form of each of the geometric elements, such as dimensional data and relationships within each of the geometric elements.

The obtaining module 102 divides the ideal image into one or more sections and obtains attributes of each of the sections. The attributes of each of the sections of the ideal image may include a serial number, a geometric element, and the attributes of each of the geometric elements. The attributes of each of the geometric elements is information concerning the construction and form of each of the geometric elements, such as dimensional data and relationships between each of the geometric elements.

The establishment module 104 establishes a coordinate system for each of the sections according to the attributes of each of the sections. For example, the establishment module 104 establishes a first coordinate system for a section A according to the attributes of the section A, establishes a second coordinate system for a section B according to the attributes of the section B, establishes a third coordinate system for a section C according to the attributes of the section C, and establishes a fourth coordinate system for a section D according to the attributes of the section D. It is understood that establishing a coordinate system for each of the sections increases the accuracy of measurement. In one embodiment, assuming that the section A includes a slope on which has a circle, if the slope is not parallel to any axis (X-axis, Y-axis or Z-axis) of the coordinate system, the circle is represented by a formula for an ellipse. If the establishment module 104 establishes the first coordinate system which has an axis (e.g., X-axis) parallel to the slope, the circle is represented by the formula for the circle.

The measurement module 106 measures a dimension of a desired position in each of the sections based on the coordinate system corresponding to each of the sections, and obtains ideal measurement data of the desired position. It is understood that the desired position is selected by a user from each of the sections. For example, the user can select a first desired position located in the section A by clicking on the first desired position using a mouse device, selects a second desired position located in the section B by clicking on the second desired position, selects a third desired position located in the section C by clicking on the third desired position and selects a fourth desired position located in the section D by clicking on the fourth desired position. The measurement module 106 measures the dimension of the first desired position located in the section A based on the first coordinate system. The measurement module 106 measures the dimension of the second desired position located in the section B based on the second coordinate system. The measurement module 106 measures the dimension of the third desired position located in the section C based on the third coordinate system. The measurement module 106 measures the dimension of the fourth desired position located in the section D based on the fourth coordinate system. The ideal measurement data of the desired position include the measured dimension of the desired position in each of the sections of the ideal image.

The programming module 108 generates a measuring program which includes programmed computerized code of the modules 100-106. The measuring program repeatedly executes from the module 100 to the module 106 in order when a user starts the measuring program. In one embodiment, when the user starts the measuring program, the measuring program reads an ideal image of the product from the storage system 12, divides the ideal image into one or more sections and obtains attributes of each of the sections, establishes a coordinate system for each of the sections according to the attributes of each of the sections and measures a dimension of a desired position in each of the sections based on the coordinate system corresponding to each of the sections, and obtains ideal measurement data of the desired position. The measuring program includes functions of the modules 100-106. Additionally, the programming module 108 displays the measuring program on the display device 2, and stores the measuring program into the storage system 12.

The reading module 100 reads a real image from storage system 12 and measures the real image by starting the measuring program to obtain real measurement data of the desired position. It is understood that the real image is generated by scanning the surface of the product using a device (e.g., a laser scanner). In one embodiment, the measuring program divides the real image into four sections, and measures the dimension of the desired position in each of the sections of the real image.

The determination module 110 determines if the real measurement data of the desired positions in the real image matches the ideal measurement data of the desired positions in the ideal image.

The color assigning module 112 assigns a color to a desired position in the real image, in response to a determination that the real measurement data of the desired position in the real image does not match the ideal measurement data of the desired position in the ideal image.

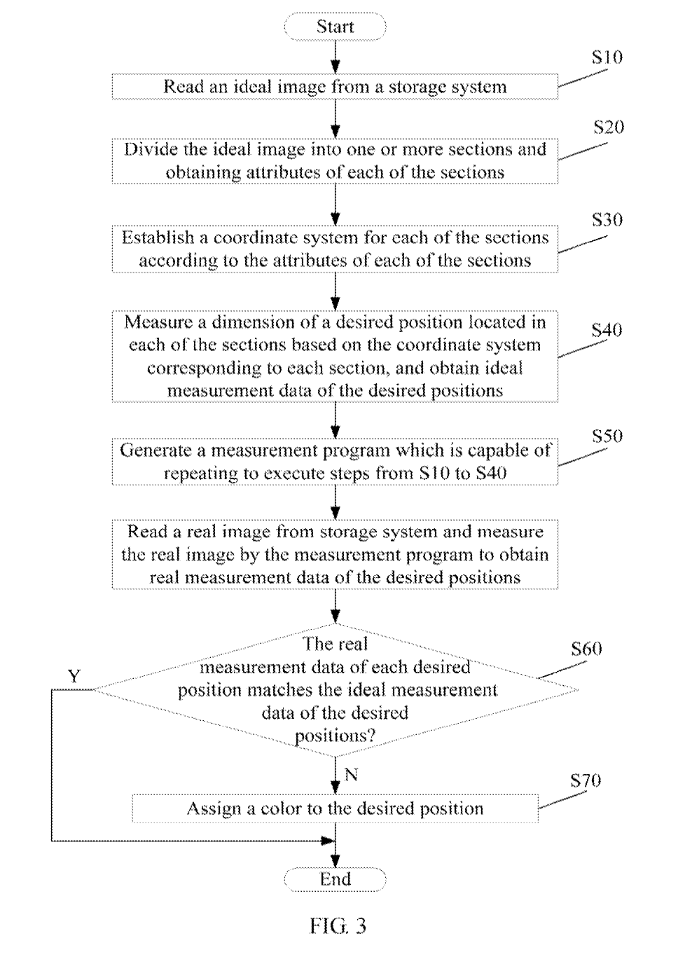

FIG. 3 is a flowchart illustrating one embodiment of an offline programming method using the computing device 1 of FIG. 1. The method can be performed by the execution of a computer-readable program by the at least one processor 12. Depending on the embodiment, in FIG. 2, additional blocks may be added, others removed, and the ordering of the blocks may be changed.

In block S10, the reading module 100 reads an ideal image from the storage system 12. In the embodiment, the ideal image may include serial numbers, geometric elements, and attributes of each of the geometric elements. For example, if the geometric element is a straight line, the attributes includes the starting point and the end point of that straight line. If the geometric element is a circle, the attributes includes the midpoint of the circle, and the calculable radius of the circle.

In block S20, the obtaining module 102 divides the ideal image into one or more sections and obtains attributes of each of the sections. The each of the sections of the ideal image may include a serial number, a geometric element, and attributes of each of the geometric elements. In one embodiment, assuming that the ideal image is divided into four sections, such as, section A, section B, section C and section D, the obtaining module 102 obtains attributes of the section A, the section B, the section C and the section D.

In block S30, the establishment module 104 establishes a coordinate system for each of the sections according to the attributes of each of the sections. For example, if the section A includes a plane and a line, the establishment module 104 establishes a first coordinate system which the axis (e.g., X-axis) is parallel to the plane and the line.

In block S40, the measurement module 106 measures a dimension of a desired position in each of the sections based on the coordinate system corresponding to each of the sections, and obtains ideal measurement data of the desired position. It is understood that the desired position in each of the sections is selected by a user. The measurement module 106 measures the dimension of the second desired position located in the section B based on the second coordinate system. The measurement module 106 measures the dimension of the third desired position located in the section C based on the third coordinate system. The measurement module 106 measures the dimension of the fourth desired position located in the section D based on the fourth coordinate system. The ideal measurement data of the desired position includes the measured dimension of the desired position in each of the sections.

In block S50, the programming module 108 generates a measuring program which is capable of repeating to execute blocks S10-S50 when a user starts the measuring program. It is understood that the measuring program is generated by programming computerized code of the modules 110-106. Additionally, the programming module 108 displays the measuring program on the display device 2, and stores the measuring program into the storage system 12.

In block S60, the reading module 100 reads a real image from storage system 12 and measures the real image by starting the measuring program to obtain real measurement data of the desired positions. It is understood that the real image is generated by scanning the surface of the product using a device (e.g., a laser scanner). In one embodiment, the measuring program divides the real image into four sections, and measures the dimension of the desired positions in the real image.

In block S70, the determination module 110 determines if the real measurement data of each desired position in the real image matches the ideal measurement data of the desired position in the ideal image. In one embodiment, if the real measurement data of each desired position in the real image matches the ideal measurement data of the desired position in the ideal image, then the procedure goes to end. If the real measurement data of any desired position in the real image does not match the ideal measurement data of the desired position in the ideal image, block S80 is implemented.

In block S80, the color assigning module 112 assigns a color to the desired position in the real image. A unique color is defined for distinguishing every tolerance range. For example, a blue-black color is assigned to a first tolerance range [−0.14 mil, −0.12 mil], a bright yellow color is assigned to a second tolerance range [+0.12 mil, +0.14 mil]. It is noted that, in this embodiment, values between the minimum boundary value and the maximum boundary value are regarded as allowable errors. In one embodiment, for example, if the real measurements from the desired position fall within the tolerance range [−0.14 mil, −0.12 mil], then the color assigning module 112 assigns the blue-black color to the desired position.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method of generating a measuring program of a computing device, the method comprising:
(a) dividing an ideal image from a storage system of the computing device into one or more sections and obtaining attributes of each of the sections;
(b) establishing a coordinate system by the computing device for each of the sections according to the attributes of each of the sections; and
(c) measuring a dimension of a desired position in each of the sections based on the coordinate system corresponding to each of the sections, and obtaining ideal measurement data of the desired position, wherein the desired position is selected by a user from each of the sections displayed on a display device.

2. The method as described in claim 1, further comprising:
measuring a real image to obtain real measurement data of the desired position;
determining if the real measurement data of the desired position matches the ideal measurement data of the desired position; and
assigning a color to the desired position in response to a determination that the real measurement data of the desired position does not match the ideal measurement data of the desired position.

3. The method as described in claim 1, wherein the ideal measurement data of the desired position comprises measured dimension of the desired position in each of the sections of the ideal image.

4. The method as described in claim 2, wherein the real measurement data of the desired position comprises measured dimension of the desired position in each of the sections of the real image.

5. The method as described in claim 1, wherein the attributes of each of the sections comprises serial numbers, geometric elements, and attributes of each of the geometric elements.

6. The method as described in claim 5, wherein the geometric elements is selected from the group consisting of a point, a line, a circle, a flat surface, a plane, a circle, a conventional surface, and a non-uniform rational basis spline (NURBS) surface.

7. The method as described in claim 5, wherein the attributes of each of the geometric elements is information concerning the construction and form of each of the geometric elements.

8. A computing device of generating a measuring program, comprising:
at least one processor;
a storage system; and
one or more programs stored in the storage system and being executable by the at least one processor, the one or more programs comprising:
an obtaining module operable to divide an ideal image into one or more sections and obtain attributes of each of the sections;
an establishment module operable to establish a coordinate system for each of the sections according to the attributes of each of the sections; and
a measurement module operable to measure a dimension of a desired position in each of the sections based on the coordinate system corresponding to each of the sections, and obtain ideal measurement data of the desired position, wherein the desired position is selected by a user from each of the sections displayed on a display device.

9. The computing device as described in claim 8, further comprising:
a reading module operable to measure the real image to obtain real measurement data of the desired position;
a determination module operable to determine if the real measurement data of the desired position matches the ideal measurement data of the desired position; and
a color assigning module operable to assign a color to the desired position in response to a determination that the real measurement data of the desired position does not match the ideal measurement data of the desired position.

10. The computing device as described in claim 8, wherein the ideal measurement data of the desired position comprises measured dimension of the desired position in each of the sections of the ideal image.

11. The computing device as described in claim 9, wherein the real measurement data of the desired position comprises measured dimension of the desired position in each of the sections of the real image.

12. The computing device as described in claim 8, wherein the attributes of each of the sections comprises serial numbers, geometric elements, and attributes of each of the geometric elements.

13. The computing device as described in claim 12, wherein the geometric elements is selected from the group consisting of a point, a line, a circle, a flat surface, a plane, a circle, a conventional surface, and a non-uniform rational basis spline (NURBS) surface.

14. The computing device as described in claim 12, wherein the attributes of each of the geometric elements is information concerning the construction and form of each of the geometric elements.

15. A non-transitory storage medium having stored thereon instructions that, when executed by a processor of a computing device, causes the computing device to perform a method of generating a measuring program, the method comprising:
(a) dividing an ideal image from a storage system of the computing device into one or more sections and obtaining attributes of each of the sections;
(b) establishing a coordinate system by the computing device for each of the sections according to the attributes of each of the sections; and
(c) measuring a dimension of a desired position in each of the sections based on the coordinate system corresponding to each of the sections, and obtaining ideal measurement data of the desired position, wherein the desired position is selected by a user from each of the sections displayed on a display device.

16. The non-transitory storage medium as described in claim 15, wherein the method further comprises:
measuring a real image to obtain real measurement data of the desired position;
determining if the real measurement data of the desired position matches the ideal measurement data of the desired position; and
assigning a color to the desired position in response to a determination that the real measurement data of the desired position does not match the ideal measurement data of the desired position.

17. The non-transitory storage medium as described in claim 15, wherein the ideal measurement data of the desired position comprises measured dimension of the desired position in each of the sections of the ideal image.

18. The non-transitory storage medium as described in claim 16, wherein the real measurement data of the desired position comprises measured dimension of the desired position in each of the sections of the real image.

19. The non-transitory storage medium as described in claim 15, wherein the attributes of each of the sections comprises serial numbers, geometric elements, attributes of each of the geometric elements, and the attributes of each of the geometric elements is information concerning the construction and form of each of the geometric elements.

20. The non-transitory storage medium as described in claim 19, wherein the geometric elements is selected from the group consisting of a point, a line, a circle, a flat surface, a plane, a circle, a conventional surface, and a non-uniform rational basis spline (NURBS) surface.
